(19) United States
(12) Patent Application Publication
(10) Pub. No.: US 2026/0213890 A1
(43) Pub. Date: Jul. 23, 2026

(54) BASE STATION, USER EQUIPMENT, METHOD

(71) Applicant: Sony Group Corporation, Tokyo (JP)

(72) Inventors: Hideji WAKABAYASHI, Basingstoke (GB); Yuxin WEI, Basingstoke (GB); Vivek SHARMA, Basingstoke (GB); Yassin Aden AWAD, Basingstoke (GB)

(73) Assignee: Sony Group Corporation, Tokyo (JP)

(21) Appl. No.: 19/144,968

(22) PCT Filed: Jan. 19, 2024
(86) PCT No.: PCT/EP2024/051309

§ 371 Date: Jul. 1, 2025

(30) Foreign Application Priority Data
Jan. 20, 2023 (EP) 23152720.1

(51) Int. Cl. H04L 1/1867; H04L 1/1812

(52) U.S. Cl. CPC H04L 1/189; H04L 1/1812

(57) ABSTRACT

The present disclosure generally pertains to a base station for a mobile telecommunications network providing multicast-broadcast service, the base station including circuitry configured to: send, to a plurality of user equipments on a multicast or broadcast channel, a data packet; determine whether a transmission of the data packet to a user equipment of the plurality of user equipment has failed; and in the case that it is determined that the transmission has failed, retransmit the data packet.

### TECHNICAL FIELD

The present disclosure generally pertains to a base station, user equipment and a method in the field of 5G industrial internet of things.

### TECHNICAL BACKGROUND

In 3GPP IoT (Internet of Things) Rel-16 and Rel-17, functions for industrial internet of things (IIoT) are introduced. These releases were made for supporting industry 4.0, factory automation, smart cities, and the like.

One feature of these releases is time sensitive communication (TSC), which may enable to handle a highly accurate time synchronization between devices, low latency traffic and highly reliable communication.

According to 3GPP, TSC should be compatible with the wired based time sensitive network (TSN). However, IIoT covers a wide variety of applications and the requirements are quite different from the conventional 3GPP applications such as voice, text, web browsing, and so on. Moreover, multicast/broadcast service (MBS) is introduced in Rel-17 in order to support public safety communication and vehicle to everything/environment (V2X) application.

Although there exist techniques for providing TSC, it is generally desirable to provide a base station, a terminal device, and a method.

### SUMMARY

According to a first aspect, the disclosure provides a base station for a mobile telecommunications network providing multicast-broadcast service, the base station comprising circuitry configured to:
send, to a plurality of user equipments on a multicast or broadcast channel, a data packet;
determine whether a transmission of the data packet to a user equipment of the plurality of user equipment has failed; and
in the case that it is determined that the transmission has failed, retransmit the data packet.

According to a second aspect, the disclosure provides a user equipment for a mobile telecommunications network providing multicast-broadcast service, the user equipment comprising circuitry configured to:
indicate whether a transmission of a data packet, which is sent on a multicast or broadcast channel, to the user equipment has failed; and
receive, in the case that the transmission has failed, the retransmitted data packet.

According to a third aspect, the disclosure provides a method carried out in a base station for a mobile telecommunications network providing multicast-broadcast service, the method comprising:
sending, to a plurality of user equipments on a multicast or broadcast channel, a data packet;
determining whether a transmission of the data packet to a user equipment of the plurality of user equipment has failed; and
in the case that it is determined that the transmission has failed, retransmitting the data packet.

According to a fourth aspect, the disclosure provides a method carried out in user equipment for a mobile telecommunications network providing multicast-broadcast service, the method comprising:
indicating whether a transmission of a data packet, which is sent on a multicast or broadcast channel, to the user equipment has failed; and
receiving, in the case that the transmission has failed, the retransmitted data packet.

Further aspects are set forth in the dependent claims, the drawings and the following description.

### BRIEF DESCRIPTION OF THE DRAWINGS

Embodiments are explained by way of example with respect to the accompanying drawings, in which:

FIG. 1 depicts an NR MBS as it is commonly known;

FIG. 2 depicts shows an IIoT network according to the present disclosure;

FIG. 3 depicts a timing diagram according to the present disclosure in which multiple retransmissions are scheduled within a delay budget of sixty milliseconds;

FIG. 4 depicts a timing diagram according to the present disclosure in which multiple retransmissions are scheduled based on an increased transmission density;

FIG. 5 depicts a timing diagram according to the present disclosure in which multiple retransmissions are scheduled with an increased transmission power compared to a first data packet;

FIG. 6 depicts a block diagram of a method carried out in a base station according to the present disclosure; and

FIG. 7 depicts a block diagram of a method carried out in a user equipment according to the present disclosure.

### DETAILED DESCRIPTION OF EMBODIMENTS

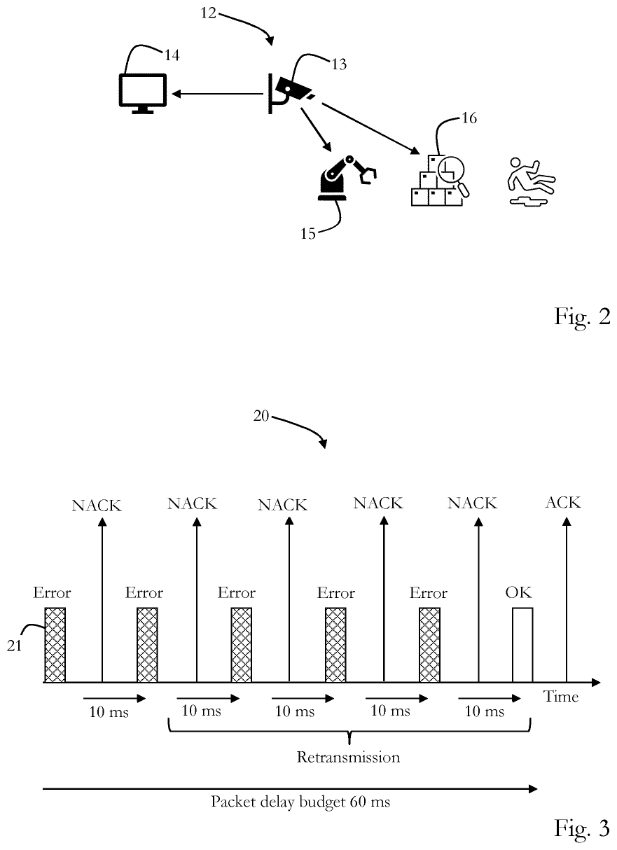

Before a detailed description of the embodiments under reference of FIG. 2 is given, general explanations are made.

In the present disclosure, the following definitions are used:

Configured Grant (CG): See patent application publication WO 2022/029112 A1: Configured Grant UCI Multiplexing on PUSCH Repetitions

Semi-persistence scheduling (SPS): See patent application publication WO 2022/152433 A1: HARQ-ACK bundling for different SPS instances in an SPS Group

Time sensitive network (TSN): See WO 2021/209235 A1 Grand Master Clock UE (DS-TT) providing uplink synchronizations for TSN

Application function (AF): An application function is an interface between TSN CNC and 5G (see below)

The following definitions are in accordance with IoT white paper, as retrieved from [1]:

TSN Solution Components: There may be five main components in TSN (time-sensitive network):

TSN flow: Term used to describe time-critical communication between end devices. Each flow has strict time requirements that the networking devices honor. Each TSN flow is uniquely identified by the network devices.

End device: Source and destination of TSN flow. The end device may run an application that may requires deterministic communication. End devices are also referred to as talkers and listeners.

Bridges: Also referred to as Ethernet switches. For TSN, these are special bridges capable of transmitting the Ethernet frames of a TSN flow on a schedule and receiving Ethernet frames of a TSN flow according to a schedule.

Central network controller (CNC): For TSN, the CNC acts as a proxy for the Network (the TSN Bridges and their interconnections) and the control applications that require deterministic communication. The CNC defines the schedule on which all TSN frames are transmitted. The CNC application is provided by the vendor of the TSN bridges.

Centralized user configuration (CUC): An application that communicates with the CNC and the end devices. The CUC represents the control applications and the end devices. The CUC makes requests to the CNC for deterministic communication (TSN flows) with specific requirements for those flows. The CUC is an application that is vendor specific. Typically, the vendor of the TSN end devices will supply a CUC for those end devices.

The following definition of TSC (time-sensitive communication) assistance information TSCAI) is in accordance with 3GPP IoT Release 17 and retrieved from: https://www.3gpp.org/news-events/3gpp-news/ind- 5g#:~:text=TSC%20Assistance%20Information%20(TSCAI)%20describes, use%20in%20the%2 05G%20System

The TSCAI may include the following parameters:

Flow direction: Direction of TSC flow (uplink or downlink)

Periodicity: Time-period between start of two bursts

Burst arrival time: Latest possible time when first packet of data burst arrives at either the ingress of RAN (radio access network) (downlink flow direction) or egress interface of a user equipment (UE) (uplink flow direction)

Survival time: As defined in 3GPP TS 22.261 (Service requirements for 5G systems); refers to a time period an application can survive without any bursts

The following definition of Fieldbus is obtained from https://en.wikipedia.org/wiki/Fieldbus:

Fieldbus is the name of a family of industrial computer networks used for real-time distributed control. Fieldbus profiles are standardized by the International Electrotechnical Commission (IEC) as IEC 61784/61158.

A complex automated industrial system is typically structured in hierarchical levels as a distributed control system (DCS). In this hierarchy the upper levels for production managements are linked to the direct control level of programmable logic controllers (PLC) via a non-time-critical communications system (e.g. Ethernet). The fieldbus links the PLCs of the direct control level to the components in the plant of the field level such as sensors, actuators, electric motors, console lights, switches, valves and contactors and replaces the direct connections via current loops or digital I/O signals. The requirement for a fieldbus are therefore time-critical and cost sensitive. Since the new millennium a number of fieldbuses based on Real-time Ethernet have been established. These have the potential to replace traditional fieldbuses in the long term.

The following definition is obtained from 3GPP TS 23.501 V17.5.0(2022 -06):

The 5G System architecture includes the following network functions (NF):
Authentication Server Function (AUSF).
Access and Mobility Management Function (AMF).
Data Network (DN), e.g. operator services, Internet access or 3rd party services.
Unstructured Data Storage Function (UDSF).
Network Exposure Function (NEF).
Network Repository Function (NRF).
Network Slice Admission Control Function (NSACF).
Network Slice-specific and SNPN Authentication and Authorization Function (NSSAAF).
Network Slice Selection Function (NSSF).
Policy Control Function (PCF).
Session Management Function (SMF).
Unified Data Management (UDM).
Unified Data Repository (UDR).
User Plane Function (UPF).
UE radio Capability Management Function (UCMF).
Application Function (AF).
User Equipment (UE).
(Radio) Access Network ((R)AN).
5G-Equipment Identity Register (5G-EIR).
Network Data Analytics Function (NWDAF).
CHarging Function (CHF).
Time Sensitive Networking AF (TSN AF).
Time Sensitive Communication and Time Synchronization Function (TSCTSF).
Data Collection Coordination Function (DCCF).
Analytics Data Repository Function (ADRF).
Messaging Framework Adaptor Function (MFAF).
Non-Seamless WLAN Offload Function (NSWOF).
   NOTE: The functionalities provided by DCCF and/or ADRF can also be hosted by an NWDAF.
Edge Application Server Discovery Function (EASDF).

The 5G System architecture also comprises the following network entities:
Service Communication Proxy (SCP).

Security Edge Protection Proxy (SEPP).

The functional descriptions of these Network Functions and entities are specified in clause 6.
Non-3GPP InterWorking Function (N3IWF).
Trusted Non-3GPP Gateway Function (TNGF).
Wireline Access Gateway Function (W-AGF).
Trusted WLAN Interworking Function (TWIF).

It has been recognized that internet of things (IoT) and industrial internet of things (IIoT) applications may be different from conventional cellular application, e.g., in the context of 5G. For example, IIoT may need to support various network topologies, such as start, ring, daisy chain (line), mesh, mixtures thereof, or the like.

In conventional cellular applications, a typical topology may be start topology (e.g. one base station sending to multiple terminal devices or user equipments (UE)), but in industrial communication, such as a factory floor, the topology may depend on a layout of a machine, requirements of communications, or the like.

It has further been recognized that known cellular systems may not be able to provide fail-safe communication, because known radio channels may be unstable and may have randomness.

Retransmission may improve error rate, but also increase a delay, whereas a safety communication may need to work immediately at an event of emergency.

Furthermore, if wired communication is replaced with 5G wireless communication, it should (ideally) meet the requirements of wired communications. For example, the ring topology communication or mesh topology communication may be used if high reliable of the communication between the network devices is required, because such topologies may be able to communicate even if one of the link is deactivated. It has been recognized that it may be desirable that, in 5G, the same reliability requirements but with alternative technology may need to be met.

It has further been recognized that various type of communication may need to be supported.

In conventional industrial communication, there may be many communication modes/types because there may be many standards/products to meet the communication requirements for various industries, such as periodic/aperiodic, synchronous/asynchronous, deterministic/non-deterministic, cyclic/event driven/, realtime/non-realtime/isochronous, or the like.

It has been recognized that 5G TSN may need to be able to connect to them and/or replace wire-based solutions with wireless ones.

In the following, definitions of different communication types are given.

### Cyclic/Event Driven

In cyclic communication, the terminal devices (also referred to as user equipment (UE)) may be get information after one another. For example, UE A>UE B>UE C>UE D, then back to start, UE A. Time slots may be pre-allocated and guaranteed to use for the specific UE. For example, transmission may be based on time division, but also other transmission types may be envisaged. For example, resources may be separated in a frequency domain or in a special domain (e.g. beam domain) if transmissions overlap in a same time slot.

On the other hand, event driven is traffic may be handled when an event (e.g., an alarm) occurs, such that such communication may be referred to as “on-demand”. However, if low latency is required, such as for a critical alarm, the traffic may need to be handled immediately. Depending on the type of event/alarm, different strategies of traffic handling may be required. Even for delay tolerant events, a time stamp when an event occurs should be accurate because a historical log may be useful for trouble shooting.

### Deterministic/Non-Deterministic

In deterministic communication, uncertainty/randomness may be removed as much as possible. The factors of uncertainty may be avoided, such as a collision of resource usage (e.g. contention, interferences), effect of channel fading (error), shortage of transmission power in an amplifier, network node overload beyond the capacity, and the like. Deterministic communication may be provided by a combination of multiple technologies. For example, the cyclic communication or periodic resource allocation may be used to provide deterministic communication.

### Synchronous/Asynchronous

Asynchronous communication may have a different meaning depending on the context. In conventional LPWA IoT (delay tolerant system), a receiver may use the signal later after a UE sends the signal. The time when the data received may be much later than the time when the data is used.

In industrial IoT, such as factory automation, an unexpected, unplanned alarm may be raised. Such an alarm may be considered as asynchronous. However, urgency may depend on a type of event/alarm. Some events may be delay tolerant, but some events should be handled immediately.

In industrial IoT, both synchronous and asynchronous traffic may need to be handled.

### Realtime/Non-Realtime/Isochronous

In 3GPP context, realtime traffic may be used for voice, video, and the like. The realtime traffic may need to be handled within an allowed delay (e.g. for voice, latency may need to be less than 100 ms). Therefore, such traffic may be handled like voice over LTE (VoLTE). On the other hand, non-real time traffic may not require such handling.

It has been recognized that, in IIoT, a further traffic class may be needed which may be called “isochronous”. Isochronous communication may provide low latency communication, very accurate time synchronization, and high reliability. It may be suitable for industrial application like motion control. The 5G TSN may be a key technology to meet this requirement.

### Periodic/Aperiodic

In periodic communication, a signal may be transmitted in regular interval. For example, a UE may repeatedly transmit a signal every 5 ms, or the like.

As indicated above, in industrial communication, there may be various combination of the different communication types, which should also be usable in 5G. More information may be obtained from the following white paper [2]

However, it has been recognized that no 3GPP standard defines how these different communication types should be taken into account by the TSN.

Moreover, it has been recognized that various types of use cases may be present in factory automation, which should still be usable in 5G IIoT. Such use cases may be shown in 3GPP TR 22.804 V16.3.0 (2020-07). In the following, some use cases are defined.

### Motion Control

In a factory, a motor/actuator may control objects to move to a predetermined position, with a predetermined speed, at a predetermined timing (e.g., conveyor belt, robots). This may be achieved based on sensors.

It has been recognized that such a system may have a feedback loop to adjust position/speed and it may require low latency, very accurate time synchronization and high reliability. It should be based on deterministic communication and may use cyclic communication to guarantee a quality of service (QoS).

### Alarm/Event

Alarm/events may occur at unexpected times. However, there may be various types of alarms/events. For example, an immediate action may be required for an alarm which shows an emergency situation. On the other hand, some events may be delay tolerant and as a first step, it may be sufficient to just record it in a log. However, in a conventional 3GPP, such diversity of events is not taken into account.

In addition, a very accurate time stamp may be required for events because a time series analysis may help with trouble-shooting.

### Non-Realtime Data

In a factory, a machine may be controlled by a computer (system), e.g., based on ERP, MES, SCADA. Large volumes of data may be trafficked, but such systems may need to be delay tolerant. In a factory environment, the real-time communication and non-realtime one may be mixing.

### Safety Communication

It has been recognized that for factory automation with 5G, it may be challenging to support safety control functions such as “emergency stop switch”, “Deadman's switch”, or the like, which may be designed to stop a machine if the human operator cannot operate it for some reason (e.g., loss of consciousness).

### Fail-Safe

Fail-safe may refer to a feature or practice that in case of a specific type of failure inherently responds in a way that will cause minimal or no harm to other equipment, environment and/or people.

### Multicast/Broadcast (Multicast-Broadcast) System (MBS)

As indicated above, in 3GPP IoT Rel-17, MBS has been introduced, but it has been recognized that MBS is not considered to IIoT.

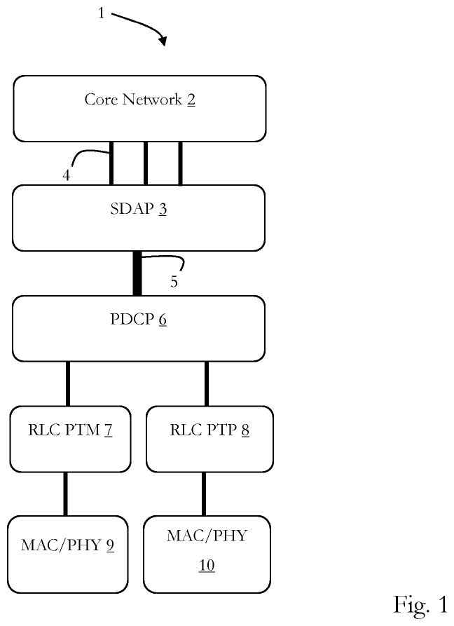

FIG. 1 a New Radio (NR) MBS 1 as it is commonly known.

The MBS 1 has two modes, broadcast mode and multicast mode, wherein, in the following, only the multicast mode is described.

A core network (CN) 1 establishes a multicast session to a UE (User Equipment). For that purpose, the CN 2 transfers MBS traffic to a RAN (Radio access network) via a SDAP (service data adaption protocol) 3. The SDAP 3 is configured to distinguish quality of service (QoS) requirements based on QoS flow(s) 4 from the CN 2. In this embodiment, only one QoS flow is mentioned for simplification, but 3GPP allows multiplexing more than one QoS flow. The SDAP 3 is configured to map a CN level QoS (i.e., per QoS flow) and to a RAN level QoS based on an allocation of an MBS radio bearer 5 in line with the RAN level QoS, which is input to a packet data convergence protocol (PDCP) 6.

The PDCP 6 was originally defined for packet header compression. Nowadays, it is in charge of more functions than the intended functions. It mainly splits the stream into segments for a packet in PDCP level and allocates sequence number (SN) for reordering. The SDAP 3 may check the SN in the header and waits for retransmission if some of packet should have been received earlier but has not been received yet. The SDAP 3 is also in charge of removing the duplicated packets if the UE receives the same packet with multiple times.

A radio link control (RLC) layer is configured to establish reliable radio link with segmentation, de-segmentation (assemble of segmented packet), allocation of RLC level sequence number (RLC SN) and automatic repeat request (ARQ), and the like.

If point to multipoint (RLC PTM 5) should be established, a group RLC is configured for multiple UEs.

However, known RLC does not support retransmissions (i.e., no ARQ at RLC for PTM).

Group RLC transfer to MAC/PHY layer 7. A base station (e.g., gNB) executes the group scheduling to the multiple UEs. The gNB sends a packet for the multiple UEs which belong to the same group (multicast group). If a UE faces an error, hybrid ARQ (HARQ) may be applied in MAC. However, HARQ in MAC is different from ARQ in RLC.

Moreover, in broadcast mode, MBS does not support HARQ level retransmissions.

In PTM radio resources may be efficiently used and a small amount of scheduling may be needed due to group signaling. However, a residual error rate is rather high because only HARQ retransmissions may be possible, but no retransmissions on RLC level.

If point to point (RLC PTP 8) should be established, a dedicated RLC is configured to a (single) UE.

In this case, RLC supports RLC level retransmission (ARQ at RLC for PTP), since the PTP mode has an acknowledgement mode (RLC-AM) which supports ARQ.

The RLC transfers the packet to MAC/PHY 10. The gNB executes the dedicated scheduling to the UE. When the UE faces an error, the UE may request a retransmission in MAC layer with HARQ. In addition, the UE may request retransmission in RLC layer with ARQ.

PTP may be highly reliable due to a rather low residual error rate. However, more radio resources may be needed due to the individual data transmission. The overhead of signaling at cell level may be large because of the dedicated signaling to a UE. In addition, the RLC level retransmission may take longer time, such that a delay may be larger if retransmission in RLC level is carried out.

For IIoT (industrial internet of things) application, lower latency operation may be preferable such as in PTM. On the other hand, very high reliability may be required such as in PTP.

It has been recognized that it may be desirable to switch from PTM (or P2M) to PTP (or P2P) in case a retransmission is required.

In such embodiments, the gNB can may select PTM (group retransmission) or PTP (retransmission for a specific UE).

Assuming there is a residual error rate of ten percent. In case of a hundred UEs in the MBS, retransmission may be needed for ten UEs, and thus, it may be reasonable to use group-common PDCCH/PDSCH (physical downlink control channel/physical data shared channel) for retransmissions. However, if there are only ten UEs in the MBS, retransmission may be needed for only one UE, such that PTP may be more flexible to change the parameters of PDSCH from the PTM first transmission.

In wire-based communication, there may be a direct connection among a controller and a sensor, such that sensing results are only used by that controller not by a different controller. Moreover, it may be difficult to interconnect different sensors with different controller.

However, it has been recognized that it may be desirable to freely deploy sensors regardless of their connections/controllers and that it may be desirable to use sensing results multiple time and/or for multiple purposes.

FIG. 2 depicts such a distribution of sensing results. FIG. 2 shows an IIoT network 12 including a camera 13, a computer 14, a machine 15, and products 16.

The camera 13 captures a video of the factory floor and of the machine 15 and the products 16.

The video is sent to the computer 14 which evaluates it and determines control signals for the machine 15, inspects the products 16, and monitors health and safety on the factory floor.

In such a system, using MBS may be efficient with regard to radio resource usage, in particular, if the sensing result should be sent to multiple devices, such as in FIG. 2. In a large factory, target UEs/devices may be hundreds or thousands and if, for example, an emergency stop should be sent to all the devices, MBS may be useful.

However, it has been recognized that IIoT UE may require both very high reliability and low latency.

However, PTM transmission may have a rather high error rate, especially if the UE has poor cellular coverage. The HARQ level retransmissions may prevent errors for a UE in poor coverage, but they may take a long time, thereby resulting in rather high latency.

On the other hand, and PTP transmission may be highly reliable due to RLC ARQ, as discussed above, but may cause a high use of radio resources and may also have a high latency (delay).

Moreover, due to circumstances which are caused by the nature of IIoT (e.g., large factory), there may be different coverage levels for different UEs.

For PTM multicast, the base station may adjust a transmission power to reduce an error, but if the transmission power is adjusted to a cell edge UE, it may be too high for other UEs.

This may be circumvented by using HARQ level retransmissions, but this may cause high latency (delay), which may need to be avoided.

Switch to PTP may be another solution for the cell edge UE because RLC level ARQ may ensure the high reliability. However, it may not meet the requirements of some IIoT applications because of its high latency.

Moreover, it has been recognized that quality of service (QoS) requirements may be different for a different types of UE/applications.

For some applications, missing sensor data may be not critical. For example, a temperature sensor for an air conditioner/room temperature control may be delay tolerant. If the UE misses some sensing results, may have low impact on an air conditioner operation in short term.

However, for some applications, missing sensor data may be critical. For example, for a Safety Limited Speed (SLS) functions, missing sensor data may increase an accident risk.

When an application requires very high reliability (e.g., safety communication), and another application does not require so high reliability (e.g., surveillance camera for human), one solution may be to use different QoS flows on different radio bearers, if the requirements are different. However, such an approach may use more radio resources.

It has been recognized that low latency/high reliability may be provided based on modified semi-persistent scheduling (SPS).

It has further been recognized, that latency requirements may be met by limiting a number of retransmissions.

Moreover, it has been recognized that reliability requirements may be met by allocating more radio resources to a specific case/channel to reduce an error rate of retransmissions, for example with the following techniques: power boosting (increase transmission power), repetition (bundling), lower modulation and coding (low MCS), and the like.

Therefore, some embodiments pertain to a base station for a mobile telecommunications network providing multicast-broadcast service, the base station comprising circuitry configured to: send, to a plurality of user equipments on a multicast or broadcast channel, a data packet; determine whether a transmission of the data packet to a user equipment of the plurality of user equipment has failed; and in the case that it is determined that the transmission has failed, retransmit the data packet.

FIG. 3 depicts a time diagram 20 according to the present disclosure. A base station sends a data packet 21 to a UE based on PTM (PDSCH Downlink). Since the UE fails to receive the data packet 21 (although it expects it, e.g., due to a scheduling or due to an arrival of an MBS packet, but not the data packet), it sends an indication that it has not received the data packet 21 with a NACK (Negative Acknowledgement; also referred to as non-acknowledgement, in some embodiments).

Based on the NACK, the base station retransmits the data packet ten milliseconds after the first time, but again, the UE does not receive it and thus, the UE again responds with NACK.

In this embodiment, a packet delay budget is sixty milliseconds, such that in total six transmissions are tried before other measure have to be taken. In this embodiment, at the sixth transmission, the UE receives the data packet 21 and thus sends a positive acknowledgement (ACK).

It should be noted that a relation between a number of retransmissions and packet error rate may be considered a trade-off. If a low error rate is required, the UE may need to repeat a retransmission request, which, however, may collide with a pre-defined QoS requirement.

In some embodiments, the data packet is retransmitted by using power boosting.

In some embodiments, the data packet is retransmitted on a multicast channel for the plurality of user equipments.

In some embodiments, the data packet is retransmitted on a unicast channel for a specific user equipment of the plurality of user equipments.

In some embodiments, the data packet is retransmitted based on a bundling of multiple retransmission packets, wherein base station receives a single hybrid automatic repeat request, HARQ, acknowledgement, with multiple retransmission packets.

In some embodiments, the single HARQ acknowledgement is a positive acknowledgement, ACK, or a negative acknowledgement, NACK.

In some embodiments, the data packet is retransmitted in accordance with a retransmission pattern.

According to the embodiments of the present disclosure, a higher quality of service can be achieved than with conventional MBS QoS. For example, if the same delay budget and error rate as with conventional MBS QoS is configured, according to the present disclosure, a traffic priority can be configured, e.g., as “very high” (for safety communications, for example), or the like. However, such a configuration cannot be achieved with conventional MBS QoS.

For example, mission critical signaling may require an error rate of 10⁻⁶ and sixty milliseconds delay budget. However, if a one-shot transmission error rate is ten percent, and if six retransmissions are utilized, the error rate is 10⁻⁶, such that each ten milliseconds, one retransmission is tried, as discussed above with reference to FIG. 3.

Hence, in some embodiments the circuitry is further configured to: determine whether the transmission has failed based on a reception of a message from the user equipment.

In some embodiments, the acknowledgement is a Negative Acknowledgement, NACK, as discussed herein.

In some embodiments, the circuitry is further configured to: determine whether the transmission has failed based on an absence of a reception of a message from the user equipment.

For example, if an uplink is disturbed, neither ACK (positive acknowledgement) or NACK (negative acknowledgement) may arrive at the base station such that the base station may automatically schedule retransmission, if it fails to receive an answer from the UE.

Hence, in such embodiments, the (absent) message is a Positive acknowledgement, ACK, or a Negative Acknowledgement, NACK.

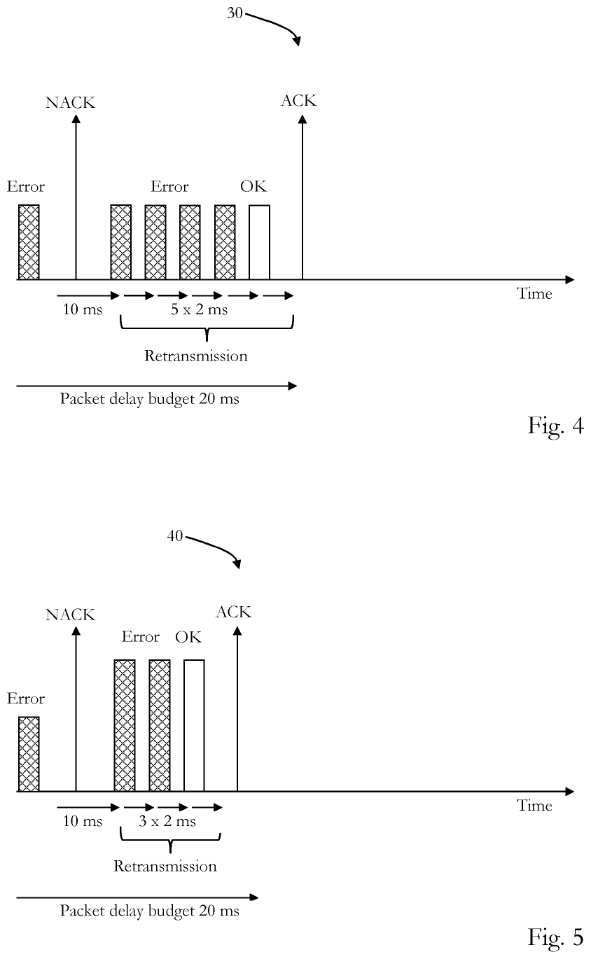

If the delay budget is small, it may be a challenge to ensure the low error rate. FIG. 4 depicts an embodiment how to secure a low error rate with a small delay budget. In FIG. 4, depicting a timing diagram 30, the packet delay budget is twenty milliseconds.

Similar to FIG. 3, the UE sends a NACK when the data packet 21 has not arrived to indicate the transmission error to the base station (gNB). The base station then schedules multiple consecutive retransmissions with unicast transmission (PDCCH/PDSCH) with a higher transmission density than in FIG. 3 (i.e., shorter time between the transmissions), i.e., every two milliseconds.

Hence, in this embodiment, the (re)transmission pattern refers to the transmission density/repetition speed, e.g., the time between transmission of data packets is shortened compared to a usual retransmission.

The UE receives the consecutive data packets without sending each acknowledgement (ACKs/NACKs). The UE sends an ACK when the packet is correctly received based on repetitions, such that the requirements of the small packet delay budget and the low packet error rate are met.

Hence, in some embodiments, the retransmission pattern is based on the packet delay budget.

In some embodiments, the retransmission pattern corresponds to an increase of a packet retransmission density, as discussed herein.

FIG. 5 depicts a timing diagram 40 according to the present disclosure in which, in contrast to the embodiment of FIG. 4, power boosts for the retransmissions are utilized.

Hence, in FIG. 5, the base station retransmits the data packet 21 in a similar way as in the embodiment of FIG. 4 (i.e., higher transmission density), but also with a higher transmission power. Thereby, the number of retransmissions may be reduced since the error rate may be decreased due to the higher transmission power.

Hence, in some embodiments, the retransmission pattern corresponds to an increase (or decrease) of a transmission power.

It should be noted that the different aspects of the embodiments of FIGS. 3 to 5 may be mixed or may be taken separately. For example, in the embodiment of FIG. 5, the transmission density of FIG. 3 may be utilized. On the other hand, only the transmission power may be increased and only one retransmission may be utilized instead of multiple retransmissions, as in the embodiments of FIGS. 3 and 4.

In other words, the retransmission pattern may vary depending on the circumstances.

It has been recognized that it may be not sufficient to use PTM, if a number of (allowed) retransmissions is below a predetermined threshold.

Hence, in some embodiments, the circuitry is further configured to: change a transmission mode in the unicast channel, if a number of allowed retransmissions (or the packet delay budget) is below a predetermined threshold.

For example, at least one of beamforming, modulation and coding, or the like may be applied for the UE.

In some embodiments, the mobile telecommunications network is a 5G network, as discussed herein. In some embodiments, the 5G network is configured for time-sensitive communication, as discussed herein.

In some embodiments, the 5G network is configured for a very low latency application.

In some embodiments, the very low latency application is an application with a latency requirement of less than fifty milliseconds.

In some embodiments, the 5G network is configured for a (very) low latency 5G quality of service identifier, 5QI, wherein the low latency 5QI has a same delay budget as a MBS 5QI, wherein a priority of the low latency 5QI is different from the MBS 5QI.

In some embodiments, the 5G network is an industrial internet of things network, as discussed herein.

Some embodiments pertain to a user equipment for a mobile telecommunications network providing multicast-broadcast service, the user equipment comprising circuitry configured to: indicate whether a transmission of a data packet, which is sent on a multicast or broadcast channel, to the user equipment has failed; and receive, in the case that the transmission has failed, the data packet.

In some embodiments, the data packet is retransmitted by using power boosting, as discussed herein. In some embodiments, the data packet is retransmitted on a multicast channel for the plurality of user equipments, as discussed herein. In some embodiments, the data packet is retransmitted on a unicast channel for a specific user equipment of the plurality of user equipments, as discussed herein. In some embodiments, the data packet is retransmitted based on a bundling of multiple retransmission packets, wherein base station receives a single hybrid automatic repeat request, HARQ, acknowledgement, with multiple retransmission packets, as discussed herein. In some embodiments, the single HARQ acknowledgement is a positive acknowledgement, ACK, or a negative acknowledgement, NACK, as discussed herein. In some embodiments, the data packet is retransmitted in accordance with a retransmission pattern, as discussed herein. In some embodiments, the circuitry is further configured to: indicate whether the transmission has failed based on a Negative Acknowledgement, NACK, as discussed herein. In some embodiments, the circuitry is further configured to: indicate whether the transmission has failed based on omitting a Positive acknowledgement, ACK, as discussed herein. In some embodiments, the retransmission pattern is based on a packet delay budget, as discussed herein. In some embodiments, the retransmission pattern corresponds to an increase of a packet retransmission density, as discussed herein. In some embodiments, the retransmission pattern corresponds to an increase of a transmission power, as discussed herein. In some embodiments, the circuitry is further configured to: receive the data packet based on a change of a transmission mode in the unicast channel, if a number of allowed retransmissions is below a predetermined threshold, as discussed herein. In some embodiments, the change of the transmission mode includes at least one of initiating beamforming, and modulation and coding, as discussed herein. In some embodiments, the mobile telecommunications network is a 5G network, as discussed herein. In some embodiments, the 5G network is configured for time-sensitive communication, as discussed herein. In some embodiments, the 5G network is configured for a very low latency application, as discussed herein. In some embodiments, the very low latency application is an application with a latency requirement of less than fifty milliseconds, as discussed herein. In some embodiments, the 5G network is configured for a low latency 5G quality of service identifier, 5QI, wherein the low latency 5QI has a same delay budget as a MBS 5QI, wherein a priority of the low latency 5QI is different from the MBS 5QI, as discussed herein. In some embodiments, the 5G network is an industrial internet of things network, as discussed herein.

Some embodiments pertain to a method carried out in a base station for a mobile telecommunications network providing multicast-broadcast service, the method including: sending, to a plurality of user equipments on a multicast or broadcast channel, a data packet; determining whether a transmission of the data packet to a user equipment of the plurality of user equipment has failed; and in the case that it is determined that the transmission has failed, retransmitting the data packet.

In some embodiments, the data packet is retransmitted by using power boosting, as discussed herein. In some embodiments, the data packet is retransmitted on a multicast channel for the plurality of user equipments, as discussed herein. In some embodiments, the data packet is retransmitted on a unicast channel for a specific user equipment of the plurality of user equipments, as discussed herein. In some embodiments, the data packet is retransmitted based on a bundling of multiple retransmission packets, wherein base station receives a single hybrid automatic repeat request, HARQ, acknowledgement, with multiple retransmission packets, as discussed herein. In some embodiments, the single HARQ acknowledgement is a positive acknowledgement, ACK, or a negative acknowledgement, NACK, as discussed herein. In some embodiments, the data packet is retransmitted in accordance with a retransmission pattern, as discussed herein. In some embodiments, the method further includes: determining whether the transmission has failed based on a reception of a message from the user equipment, as discussed herein. In some embodiments, the acknowledgement is a Negative Acknowledgement, NACK, as discussed herein. In some embodiments, the method further includes: determining whether the transmission has failed based on an absence of a reception of a message from the user equipment, as discussed herein. In some embodiments, the message is a Positive acknowledgement, ACK, or a Negative Acknowledgement, NACK, as discussed herein. In some embodiments, the retransmission pattern is based on a packet delay budget, as discussed herein. In some embodiments, the retransmission pattern corresponds to an increase of a packet retransmission density, as discussed herein. In some embodiments, the retransmission pattern corresponds to an increase of a transmission power, as discussed herein. In some embodiments, the method further includes: changing a transmission mode in the unicast channel, if a number of allowed retransmission is below a predetermined threshold, as discussed herein. In some embodiments, the change of the transmission mode includes at least one of initiating beamforming, and modulation and coding, as discussed herein. In some embodiments, the mobile telecommunications network is a 5G network, as discussed herein. In some embodiments, the 5G network is configured for time-sensitive communication, as discussed herein. In some embodiments, the 5G network is configured for a very low latency application, as discussed herein. In some embodiments, the very low latency application is an application with a latency requirement of less than fifty milliseconds, as discussed herein. In some embodiments, the 5G network is configured for a low latency 5G quality of service identifier, 5QI, wherein the low latency 5QI has a same delay budget as a MBS 5QI, wherein a priority of the low latency 5QI is different from the MBS 5QI, as discussed herein. In some embodiments, the 5G network is an industrial internet of things network, as discussed herein.

Some embodiments pertain to a method carried out in user equipment for a mobile telecommunications network providing multicast-broadcast service, the method including: indicating whether a transmission of a data packet, which is sent on a multicast or broadcast channel, to the user equipment has failed; and receiving, in the case that the transmission has failed, the retransmitted data packet.

In some embodiments, the data packet is retransmitted by using power boosting, as discussed herein. In some embodiments, the data packet is retransmitted on a multicast channel for the plurality of user equipments, as discussed herein. In some embodiments, the data packet is retransmitted on a unicast channel for a specific user equipment of the plurality of user equipments, as discussed herein. In some embodiments, the data packet is retransmitted based on a bundling of multiple retransmission packets, wherein base station receives a single hybrid automatic repeat request, HARQ, acknowledgement, with multiple retransmission packets, as discussed herein. In some embodiments, the single HARQ acknowledgement is a positive acknowledgement, ACK, or a negative acknowledgement, NACK, as discussed herein. In some embodiments, the data packet is retransmitted in accordance with a retransmission pattern, as discussed herein. In some embodiments, the method further includes: indicating whether the transmission has failed based on a Negative Acknowledgement, NACK, as discussed herein. In some embodiments, the method further includes: indicating whether the transmission has failed based on omitting an Positive acknowledgement, ACK, as discussed herein. In some embodiments, the retransmission pattern is based on a packet delay budget, as discussed herein. In some embodiments, the retransmission pattern corresponds to an increase of a packet retransmission density, as discussed herein. In some embodiments, the retransmission pattern corresponds to an increase of a transmission power, as discussed herein. In some embodiments, the method further includes: receiving the data packet based on a change of a transmission mode in the unicast channel, if a number of allowed retransmission is below a predetermined threshold, as discussed herein. In some embodiments, the change of the transmission mode includes at least one of initiating beamforming, and modulation and coding, as discussed herein. In some embodiments, the mobile telecommunications network is a 5G network, as discussed herein. In some embodiments, the 5G network is configured for time-sensitive communication, as discussed herein. In some embodiments, the 5G network is configured for a very low latency application, as discussed herein. In some embodiments, the very low latency application is an application with a latency requirement of less than fifty milliseconds, as discussed herein. In some embodiments, the 5G network is configured for a low latency 5G quality of service identifier, 5QI, wherein the low latency 5QI has a same delay budget as a MBS 5QI, wherein a priority of the low latency 5QI is different from the MBS 5QI, as discussed herein. In some embodiments, the 5G network is an industrial internet of things network, as discussed herein. The methods as described herein are also implemented in some embodiments as a computer program causing a computer and/or a processor to perform the method, when being carried out on the computer and/or processor. In some embodiments, also a non-transitory computer-readable recording medium is provided that stores therein a computer program product, which, when executed by a processor, such as the processor described above, causes the methods described herein to be performed.

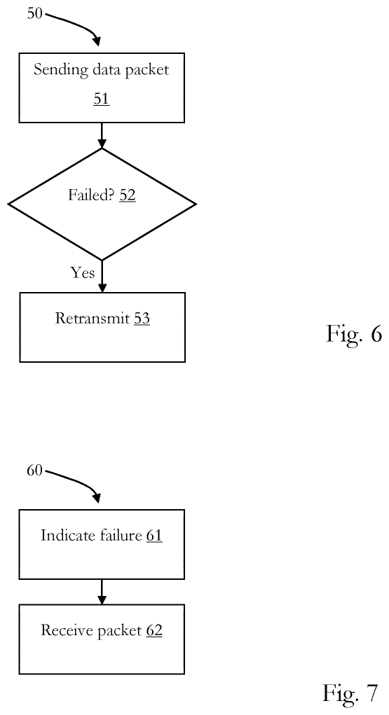

FIG. 6 depicts a block diagram of a method 50 carried out in a base station according to the present disclosure.

At 51, a data packet is sent via multicast, as discussed herein.

At 52, it is determined whether transmission of the data packet has failed (or was successful, in some embodiments).

At 53, the data packet is retransmitted according to a transmission pattern via unicast, as discussed herein.

FIG. 7 depicts a block diagram of a method 60 carried out in a user equipment according to the present disclosure.

At 61, a failure is indicated, as discussed herein.

At 62 the data packet is received on a unicast channel according to a transmission pattern, as discussed herein.

It should be recognized that the embodiments describe methods with an exemplary ordering of method steps. The specific ordering of method steps is however given for illustrative purposes only and should not be construed as binding.

In some embodiments, also a non-transitory computer-readable recording medium is provided that stores therein a computer program product, which, when executed by a processor, such as the processor described above, causes the method described to be performed.

All units and entities described in this specification and claimed in the appended claims can, if not stated otherwise, be implemented as integrated circuit logic, for example on a chip, and functionality provided by such units and entities can, if not stated otherwise, be implemented by software.

In so far as the embodiments of the disclosure described above are implemented, at least in part, using software-controlled data processing apparatus, it will be appreciated that a computer program providing such software control and a transmission, storage or other medium by which such a computer program is provided are envisaged as aspects of the present disclosure.

Note that the present technology can also be configured as described below.
(1) A base station for a mobile telecommunications network providing multicast-broadcast service, the base station comprising circuitry configured to:
   send, to a plurality of user equipments on a multicast or broadcast channel, a data packet;
   determine whether a transmission of the data packet to a user equipment of the plurality of user equipment has failed; and
   in the case that it is determined that the transmission has failed, retransmit the data packet.
(2) The base station of (1), wherein the data packet is retransmitted by using power boosting.
(3) The base station of (1) or (2), wherein the data packet is retransmitted on a multicast channel for the plurality of user equipments.
(4) The base station of anyone of (1) to (3), wherein the data packet is retransmitted on a unicast channel for a specific user equipment of the plurality of user equipments.
(5) The base station of anyone of (1) to (4), wherein the data packet is retransmitted based on a bundling of multiple retransmission packets, wherein base station receives a single hybrid automatic repeat request, HARQ, acknowledgement, with multiple retransmission packets.
(6) The base station of (5), wherein the single HARQ acknowledgement is a positive acknowledgement, ACK, or a negative acknowledgement, NACK.
(7) The base station of anyone of (1) to (6), wherein the data packet is retransmitted in accordance with a retransmission pattern.
(8) The base station of anyone of (1) to (7), wherein the circuitry is further configured to:
   determine whether the transmission has failed based on a reception of a message from the user equipment.
(9) The base station of anyone of (1) to (8), wherein the acknowledgement is a Negative Acknowledgement, NACK.
(10) The base station of anyone of (1) to (9), wherein the circuitry is further configured to:
   determine whether the transmission has failed based on an absence of a reception of a message from the user equipment.
(11) The base station of (10), wherein the message is an Positive acknowledgement, ACK, or a Negative Acknowledgement, NACK.
(12) The base station of anyone of (1) to (11), wherein the retransmission pattern is based on a packet delay budget.
(13) The base station of anyone of (1) to (12), wherein the retransmission pattern corresponds to an increase of a packet retransmission density.
(14) The base station of anyone of (1) to (13), wherein the retransmission pattern corresponds to an increase of a transmission power.
(15) The base station of anyone of (1) to (14), wherein the circuitry is further configured to:
   change a transmission mode in the unicast channel, if a number of allowed retransmission is below a predetermined threshold.
(16) The base station of (15), wherein the change of the transmission mode includes at least one of initiating beamforming, and modulation and coding.
(17) The base station of anyone of (1) to (16), wherein the mobile telecommunications network is a 5G network.
(18) The base station of (17), wherein the 5G network is configured for time-sensitive communication.
(19) The base station of (17), wherein the 5G network is configured for a very low latency application.
(20) The base station of (19), wherein the very low latency application is an application with a latency requirement of less than fifty milliseconds.
(21) The base station of anyone of (17) to (20), wherein the 5G network is configured for a low latency 5G quality of service identifier, 5QI, wherein the low latency 5QI has a same delay budget as a MBS 5QI, wherein a priority of the low latency 5QI is different from the MBS 5QI.
(22) The base station of anyone of (17) to (21), wherein the 5G network is an industrial internet of things network.
(23) A user equipment for a mobile telecommunications network providing multicast-broadcast service, the user equipment comprising circuitry configured to:
   indicate whether a transmission of a data packet, which is sent on a multicast or broadcast channel, to the user equipment has failed; and
   receive, in the case that the transmission has failed, the retransmitted data packet.
(24) The user equipment of (23), wherein the data packet is retransmitted by using power boosting.
(25) The user equipment of (23) or (24), wherein the data packet is retransmitted on a multicast channel for the plurality of user equipments.
(26) The user equipment of anyone of (23) to (25), wherein the data packet is retransmitted on a unicast channel for a specific user equipment of the plurality of user equipments.
(27) The user equipment of anyone of (23) to (26), wherein the data packet is retransmitted based on a bundling of multiple retransmission packets, wherein base station receives a single hybrid automatic repeat request, HARQ, acknowledgement, with multiple retransmission packets.
(28) The user equipment of (27), wherein the single HARQ acknowledgement is a positive acknowledgement, ACK, or a negative acknowledgement, NACK.
(29) The user equipment of anyone of (23) to (28), wherein the data packet is retransmitted in accordance with a retransmission pattern.
(30) The user equipment of anyone of (23) to (29), wherein the circuitry is further configured to:
   indicate whether the transmission has failed based on a Negative Acknowledgement, NACK.
(31) The user equipment of anyone of (23) to (30), wherein the circuitry is further configured to:
   indicate whether the transmission has failed based on omitting an Positive acknowledgement, ACK.
(32) The user equipment of anyone of (23) to (31), wherein the retransmission pattern is based on a packet delay budget.
(33) The user equipment of anyone of (23) to (32), wherein the retransmission pattern corresponds to an increase of a packet retransmission density.
(34) The user equipment of anyone of (23) to (33), wherein the retransmission pattern corresponds to an increase of a transmission power.
(35) The user equipment of anyone of (23) to (34), wherein the circuitry is further configured to:
   receive the data packet based on a change of a transmission mode in the unicast channel, if a number of allowed retransmission is below a predetermined threshold.
(36) The user equipment of (35), wherein the change of the transmission mode includes at least one of initiating beamforming, and modulation and coding.
(37) The user equipment of anyone of (23) to (36), wherein the mobile telecommunications network is a 5G network.
(38) The user equipment of (37), wherein the 5G network is configured for time-sensitive communication.
(39) The user equipment of (37), wherein the 5G network is configured for a very low latency application.
(40) The user equipment of (39), wherein the very low latency application is an application with a latency requirement of less than fifty milliseconds.
(41) The user equipment of anyone of (37) to (40), wherein the 5G network is configured for a low latency 5G quality of service identifier, 5QI, wherein the low latency 5QI has a same delay budget as a MBS 5QI, wherein a priority of the low latency 5QI is different from the MBS 5QI.
(42) The user equipment of anyone of (37) to (41), wherein the 5G network is an industrial internet of things network.
(43) A method carried out in a base station for a mobile telecommunications network providing multicast-broadcast service, the method comprising:
   sending, to a plurality of user equipments on a multicast or broadcast channel, a data
   determining whether a transmission of the data packet to a user equipment of the plurality of user equipment has failed; and
   in the case that it is determined that the transmission has failed, retransmitting the data packet.
(44) The method of (43), wherein the data packet is retransmitted by using power boosting.
(45) The method of (43) to (44), wherein the data packet is retransmitted on a multicast channel for the plurality of user equipments.
(46) The method of anyone of (43) to (45), wherein the data packet is retransmitted on a unicast channel for a specific user equipment of the plurality of user equipments.
(47) The method of anyone of (43) to (46), wherein the data packet is retransmitted based on a bundling of multiple retransmission packets, wherein base station receives a single hybrid automatic repeat request, HARQ, acknowledgement, with multiple retransmission packets.
(48) The method of (47), wherein the single HARQ acknowledgement is a positive acknowledgement, ACK, or a negative acknowledgement, NACK.
(49) The method of anyone of (43) to (48), wherein the data packet is retransmitted in accordance with a retransmission pattern.
(50) The method of anyone of (43) to (49), further comprising:
   determining whether the transmission has failed based on a reception of a message from the user equipment.
(51) The method of (50), wherein the acknowledgement is a Negative Acknowledgement, NACK.
(52) The method of anyone of (43) to (51), further comprising:
   determining whether the transmission has failed based on an absence of a reception of a message from the user equipment.
(53) The method of (52), wherein the message is an Positive acknowledgement, ACK, or a Negative Acknowledgement, NACK.
(54) The method of anyone of (43) to (53), wherein the retransmission pattern is based on a packet delay budget.
(55) The method of anyone of (43) to (54), wherein the retransmission pattern corresponds to an increase of a packet retransmission density.
(56) The method of anyone of (43) to (55), wherein the retransmission pattern corresponds to an increase of a transmission power.
(57) The method of anyone of (43) to (56), further comprising:
   changing a transmission mode in the unicast channel, if a number of allowed retransmission is below a predetermined threshold.
(58) The method of (57), wherein the change of the transmission mode includes at least one of initiating beamforming, and modulation and coding.
(59) The method of anyone of (43) to (58), wherein the mobile telecommunications network is a 5G network.
(60) The method of (59), wherein the 5G network is configured for time-sensitive communication.
(61) The method of (60), wherein the 5G network is configured for a very low latency application.
(62) The method of (61), wherein the very low latency application is an application with a latency requirement of less than fifty milliseconds.
(63) The method of anyone of (59) to (62), wherein the 5G network is configured for a low latency 5G quality of service identifier, 5QI, wherein the low latency 5QI has a same delay budget as a MBS 5QI, wherein a priority of the low latency 5QI is different from the MBS 5QI.
(64) The method of anyone of (59) to (63), wherein the 5G network is an industrial internet of things network.
(65) A method carried out in user equipment for a mobile telecommunications network providing multicast-broadcast service, the method comprising:
   indicating whether a transmission of a data packet, which is sent on a multicast or broadcast channel, to the user equipment has failed; and
   receiving, in the case that the transmission has failed, the retransmitted data packet.
(66) The method of (65), wherein the data packet is retransmitted by using power boosting.
(67) The method of (65) or (66), wherein the data packet is retransmitted on a multicast channel for the plurality of user equipments.
(68) The method of anyone of (65) to (67), wherein the data packet is retransmitted on a unicast channel for a specific user equipment of the plurality of user equipments.
(69) The method of anyone of (65) to (68), wherein the data packet is retransmitted based on a bundling of multiple retransmission packets, wherein base station receives a single hybrid automatic repeat request, HARQ, acknowledgement, with multiple retransmission packets.
(70) The method of (69), wherein the single HARQ acknowledgement is a positive acknowledgement, ACK, or a negative acknowledgement, NACK.
(71) The method of anyone of (65) to (70), wherein the data packet is retransmitted in accordance with a retransmission pattern.
(72) The method of anyone of (65) to (71), further comprising:
   indicating whether the transmission has failed based on a Negative Acknowledgement, NACK.
(73) The method of anyone of (65) to (72), further comprising:
   indicating whether the transmission has failed based on omitting an Positive acknowledgement, ACK.
(74) The method of anyone of (65) to (73), wherein the retransmission pattern is based on a packet delay budget.
(75) The method of anyone of (65) to (74), wherein the retransmission pattern corresponds to an increase of a packet retransmission density.
(76) The method of anyone of (65) to (75), wherein the retransmission pattern corresponds to an increase of a transmission power.
(77) The method of anyone of (65) to (76), further comprising:
   receiving the data packet based on a change of a transmission mode in the unicast channel, if a number of allowed retransmission is below a predetermined threshold.
(78) The method of (77), wherein the change of the transmission mode includes at least one of initiating beamforming, and modulation and coding.
(79) The method of anyone of (65) to (78), wherein the mobile telecommunications network is a 5G network.
(80) The method of (79), wherein the 5G network is configured for time-sensitive communication.
(81) The method of (79) or (80), wherein the 5G network is configured for a very low latency application.
(82) The method of (81), wherein the very low latency application is an application with a latency requirement of less than fifty milliseconds.
(83) The method of anyone of (79) to (82), wherein the 5G network is configured for a low latency 5G quality of service identifier, 5QI, wherein the low latency 5QI has a same delay budget as a MBS 5QI, wherein a priority of the low latency 5QI is different from the MBS 5QI.
(84) The method of anyone of (79) to (83), wherein the 5G network is an industrial internet of things network.
(85) A computer program comprising program code causing a computer to perform the method according to anyone of (43) to (64) and/or (65) to (84), when being carried out on a computer.
(86) A non-transitory computer-readable recording medium that stores therein a computer program product, which, when executed by a processor, causes the method according to anyone of (43) to (64) and/or (65) to (84) to be performed.

### REFERENCES

[1] https://www.cisco.com/c/dam/en/us/solutions/collateral/industry-solutions/white-paper-c11-738950.pdf
[2] https://5g-acia.org/wp-content/uploads/2021/04/5G-ACIA_Integration-of-Industrial-Ethernet-Networks-with-5G-Networks-.pdf

1. A base station for a mobile telecommunications network providing multicast-broadcast service, the base station comprising circuitry configured to:
send, to a plurality of user equipments on a multicast or broadcast channel, a data packet;
determine whether a transmission of the data packet to a user equipment of the plurality of user equipment has failed; and
in the case that it is determined that the transmission has failed, retransmit the data packet.

2. The base station of claim 1, wherein the data packet is retransmitted by using power boosting.

3. The base station of claim 1, wherein the data packet is retransmitted on a multicast channel for the plurality of user equipments.

4. The base station of claim 1, wherein the data packet is retransmitted on a unicast channel for a specific user equipment of the plurality of user equipments.

5. The base station of claim 1, wherein the data packet is retransmitted based on a bundling of multiple retransmission packets, wherein base station receives a single hybrid automatic repeat request, HARQ, acknowledgement, with multiple retransmission packets.

6. The base station of claim 5, wherein the single HARQ acknowledgement is a positive acknowledgement, ACK, or a negative acknowledgement, NACK.

7. The base station of claim 1, wherein the data packet is retransmitted in accordance with a retransmission pattern.

8. The base station of claim 1, wherein the circuitry is further configured to:
determine whether the transmission has failed based on a reception of a message from the user equipment.

9. The base station of claim 8, wherein the message is a negative Acknowledgement, NACK.

10. The base station of claim 1, wherein the circuitry is further configured to:
determine whether the transmission has failed based on an absence of a reception of a message from the user equipment.

11.-22. (canceled)

23. A user equipment for a mobile telecommunications network providing multicast-broadcast service, the user equipment comprising circuitry configured to:
indicate whether a transmission of a data packet, which is sent on a multicast or broadcast channel, to the user equipment has failed; and
receive, in the case that the transmission has failed, the retransmitted data packet.

24. The user equipment of claim 23, wherein the data packet is retransmitted by using power boosting.

25. The user equipment of claim 23, wherein the data packet is retransmitted on a multicast channel for the plurality of user equipments.

26. The user equipment of claim 23, wherein the data packet is retransmitted on a unicast channel for a specific user equipment of the plurality of user equipments.

27. The user equipment of claim 23, wherein the data packet is retransmitted based on a bundling of multiple retransmission packets, wherein base station receives a single hybrid automatic repeat request, HARQ, acknowledgement, with multiple retransmission packets,

28. The user equipment of claim 27, wherein the single HARQ acknowledgement is a positive acknowledgement, ACK, or a negative acknowledgement, NACK.

29. The user equipment of claim 23, wherein the data packet is retransmitted in accordance with a retransmission pattern.

30. The user equipment of claim 23, wherein the circuitry is further configured to:
indicate whether the transmission has failed based on a Negative Acknowledgement, NACK.

31. The user equipment of claim 23, wherein the circuitry is further configured to:
indicate whether the transmission has failed based on omitting an Positive acknowledgement, ACK.

32.-42. (canceled)

43. A method carried out in a base station for a mobile telecommunications network providing multicast-broadcast service, the method comprising:
sending, to a plurality of user equipments on a multicast or broadcast channel, a data packet;
determining whether a transmission of the data packet to a user equipment of the plurality of user equipment has failed; and
in the case that it is determined that the transmission has failed, retransmitting the data packet.

44.-84. (canceled)
